(19) United States
(12) Patent Application Publication
(10) Pub. No.: US 2017/0333740 A1
(43) Pub. Date: Nov. 23, 2017

(54) Fire Extinguishing Chimney Bomb and Method

(71) Applicant: Darin Church, Deep Gap, NC (US)

(72) Inventor: Darin Church, Deep Gap, NC (US)

(21) Appl. No.: 15/600,547

(22) Filed: May 19, 2017

Related U.S. Application Data
(60) Provisional application No. 62/339,004, filed on May 19, 2016.

(51) Int. Cl. A62C 99/00; A62C 3/04; C08L 23/06

(52) U.S. Cl. CPC A62C 99/009; C08L 23/06; A62C 99/0045; A62C 3/04; B01D 2257/104; C08L 2207/062; C08L 2207/066

(57) ABSTRACT

A fire extinguishing chimney bomb is disclosed herein. The device may include a flexible plastic receptacle and a fire extinguishing payload contained therein. The device is dropped down from the top of the chimney into the base of the fire. As the device enters the fire, heat from the fire melts the plastic, thereby releasing the extinguisher agent, which smothers the fuel and extinguishes the fire.

### CROSS-REFERENCE TO RELATED APPLICATION

The present application is related to and claims priority to U.S. Provisional Patent Application No. 62/339,004 filed May 19, 2016, which is incorporated by reference herein in its entirety.

### BACKGROUND OF THE DISCLOSURE

The following includes information that may be useful in understanding the present disclosure. It is not an admission that any of the information provided herein is prior art nor material to the presently described or claimed disclosures, nor that any publication or document that is specifically or implicitly referenced is prior art.

### Field of the Disclosure

The present disclosure relates generally to the field of safety devices of existing art and more specifically relates to fire extinguishers.

Wood stoves are commonly used in most parts of the world to heat residences. However, heating with wood can be potentially dangerous, especially when stoves and chimneys are not well cleaned or maintained. People with active chimneys in their home may need to keep constant watch their wood burning stove to monitor safe operation. Nonetheless, chimney fires occur on occasion, and can be difficult and dangerous to extinguish before damage is done to the residence or residents are put in danger. Some extinguishing methods, such as pouring water into the stove, may be ineffective or cause damage to the stove and chimney. Fast response and efficient extinguishing methods should be easily available to homeowners utilizing such heating systems. A suitable solution is desired.

### Description of Related Art

U.S. Pat. No. 9,149,672 to Bader Shafaqa Al-Anzi relates to encapsulated fire extinguishing agents. The described encapsulated fire extinguishing agent includes sealed outer shell containing at least one fire extinguishing agent therein. The shell is formed of material that melts when exposed to extreme heat, as in a fire. One embodiment has a single outer shell with a single fire retardant agent therein. Other embodiments may have a second shell within the outer shell, each shell defining an interior volume containing a separate fire extinguishing agent. The agents may combine to form a more effective fire extinguishing agent when the two shells melt.

### BRIEF SUMMARY OF THE DISCLOSURE

In view of the foregoing disadvantages inherent in the known fire extinguisher art, the present disclosure provides a novel fire extinguishing chimney bomb and method. The general purpose of the present disclosure, which will be described subsequently in greater detail, is to provide a fire extinguishing chimney bomb and method.

A fire extinguishing device is disclosed herein. The fire extinguishing device includes a payload including a fire extinguishing agent configured to smother a chimney fire, and a receptacle configured to contain the payload, to be thrown by hand, and to rupture and disperse the fire extinguishing agent upon exposure to heat above a predetermined temperature.

According to another embodiment, a method of extinguishing a fire in a chimney is also disclosed herein. The method of extinguishing a fire in a chimney includes the steps of inserting a fire extinguishing device into a chimney flue, the fire extinguishing device including a fire extinguishing agent contained within a receptacle, dropping the fire extinguishing device into proximity of the fire within the chimney, dispersing the fire extinguishing agent from the receptacle when in proximity to the fire, and extinguishing the fire.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and methods of use for the present disclosure, a fire extinguishing chimney bomb and method, constructed and operative according to the teachings of the present disclosure.

FIG. 1 is a perspective view of a fire extinguishing device during an in-use condition, according to an embodiment of the disclosure.

FIG. 2 is a pre-assembly view of the fire extinguishing device of FIG. 1, according to an embodiment of the present disclosure.

FIG. 3 is a detailed perspective view of the fire extinguishing device of FIG. 1 during an ‘in-use’ condition, according to an embodiment of the present disclosure.

FIG. 4 is a perspective view of the fire extinguishing device of FIG. 1 during an ‘in-use’ condition, according to an embodiment of the present disclosure.

FIG. 5 is a flow diagram illustrating a method of extinguishing a chimney fire, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to a fire extinguishers and more particularly to a fire extinguishing chimney bomb and method as used to aid in extinguishing a chimney fire.

Many buildings have fireplaces or wood burning stoves which can present hazards if chimney fires occur. The fire extinguishing chimney bomb provides homeowners with a safe, efficient, and easy method of putting out chimney fires. It may include a plastic bag full of ABC dry chemical powder which melts when thrown into the hot chimney The device extinguishes chimney fires quickly, before they become out of control hazards and cause serious destruction or injury. The device allows users to extinguish chimney fires in a more fast and efficient manner than alternative methods. The fire extinguishing chimney bomb may further include a receptacle and a payload.

Generally, the fire extinguishing chimney bomb is plastic bag filled with ABC type dry chemical powder capable of extinguishing chimney fires in a safe manner without cracking the flue. The bag may be filled with dry chemical powder in order to efficiently extinguish fires before the fire department arrives. A user may simply climb onto the roof of their home and drop the bag into a smoking chimney The plastic bag melts once it comes into contact with a temperature above 300 degrees Fahrenheit, thereby releasing the ABC dry chemical powder. The chemical powder may quell the flames without the need for water or other fire extinguishing methods. The fire extinguishing chimney bomb may be constructed using plastic and other suitable materials. The bag may measure approximately four inches in length and six inches in width, heat sealed on both ends. A customized label identifying the device's use and contents may also be placed on the top surface of the bag. Exact size, measurement, construction, and design specifications may vary upon manufacturing.

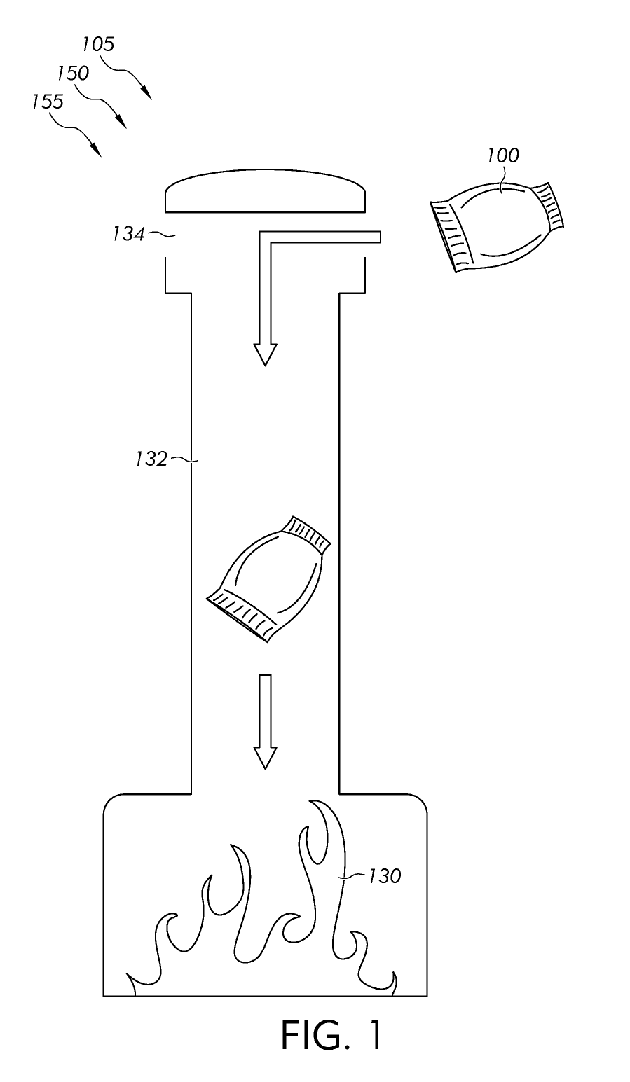

Referring now more specifically to the drawings by numerals of reference, there is shown in FIGS. 1-4, various views of a fire extinguishing device 100. The fire extinguishing chimney bomb may include a payload and a receptacle for containing the payload. The payload may include a fire extinguishing agent which extinguishes a chimney fire by smothering the fuel source of the fire. The receptacle contains the payload, and may be thrown by hand. The receptacle may rupture and disperse the fire extinguishing agent upon exposure to a heat source, especially a chimney fire, above a predetermined temperature of 300 degrees Fahrenheit.

FIG. 1 shows a fire extinguishing device during an ‘in-use’ condition 150, according to an embodiment of the present disclosure. Here, the fire extinguishing device may be beneficial for use by a user to extinguish a chimney fire. Further, the fire extinguishing device 100 may be configured to extinguish chimney fire 130. For example, the fire extinguishing device 100 may include a low-friction exterior surface configured to slide through chimney flue 134 and chimney 132.

According to one embodiment, the fire extinguishing device 100 may be arranged as a kit 105. In particular, the fire extinguishing device 100 may further include a set of instructions 155. The instructions 155 may detail functional relationships in relation to the structure of the fire extinguishing device 100 (such that the fire extinguishing device 100 can be used, maintained, or the like, in a preferred manner).

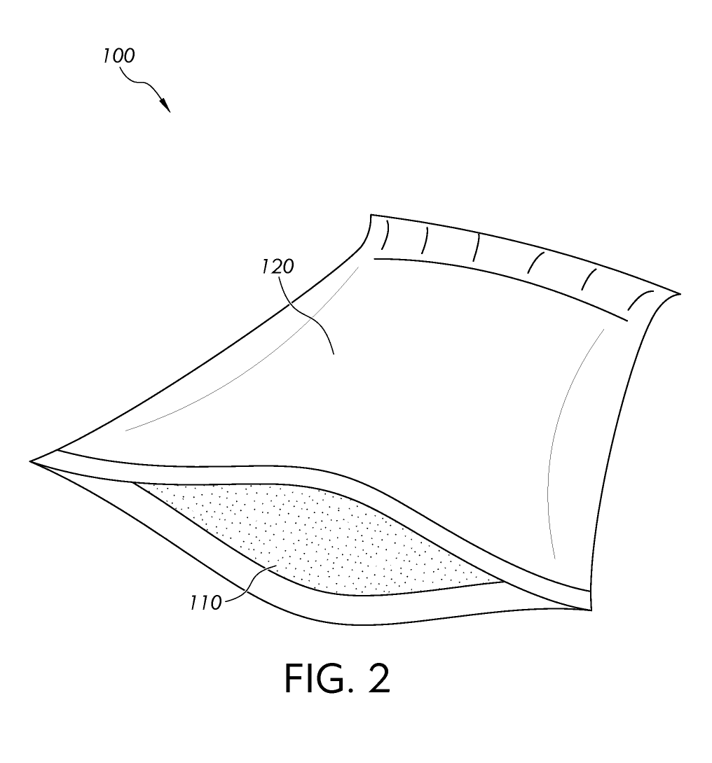

FIG. 2 is a pre-assembly perspective view of the fire extinguishing device of FIG. 1, according to an embodiment of the present disclosure. As shown, the fire extinguishing device 100 may include payload 110 contained within a receptacle 120. The receptacle 120 may be flexible and may be hermetically sealed, being configured to isolate payload 110. The receptacle 120 may be constructed of a polymer having a melting point below three hundred degrees Fahrenheit, with the receptacle 120 being configured to melt and release the payload 110. The receptacle 120 may be thrown by hand, and may be constructed of low-density polyethylene or high-density polyethylene. The payload 110 may be configured to smother a fire and prevent a combustion reaction.

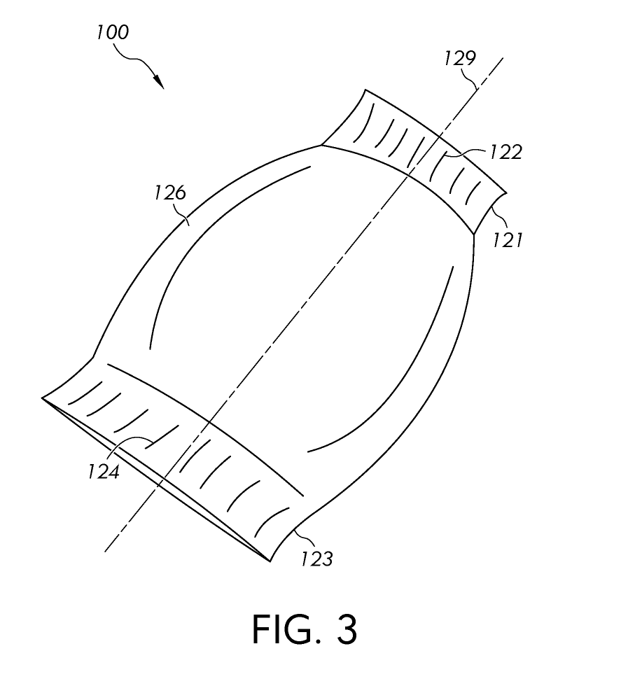

FIG. 3 is a detailed perspective view of the fire extinguishing device of FIG. 1, according to an embodiment of the present disclosure. As illustrated, the fire extinguishing device 100 may include cylindrical sheet 126 having a first end 122, a second end 124 opposite the first end 122 along a center axis of cylinder 129, a first sealed edge 121 closing first end 122 of cylindrical sheet 126, and a second sealed edge 123 closing second end 124 of cylindrical sheet 126.

According to one embodiment, the cylindrical sheet 126 may have a four inch diameter and a six inch axial length. First sealed end 121 and second sealed end 123 may include plastic welded seams. Cylindrical sheet 126 may measure no more than two millimeters thick, said the cylindrical sheet 126 being configured to immediately rupture upon heating to over three hundred degrees Fahrenheit.

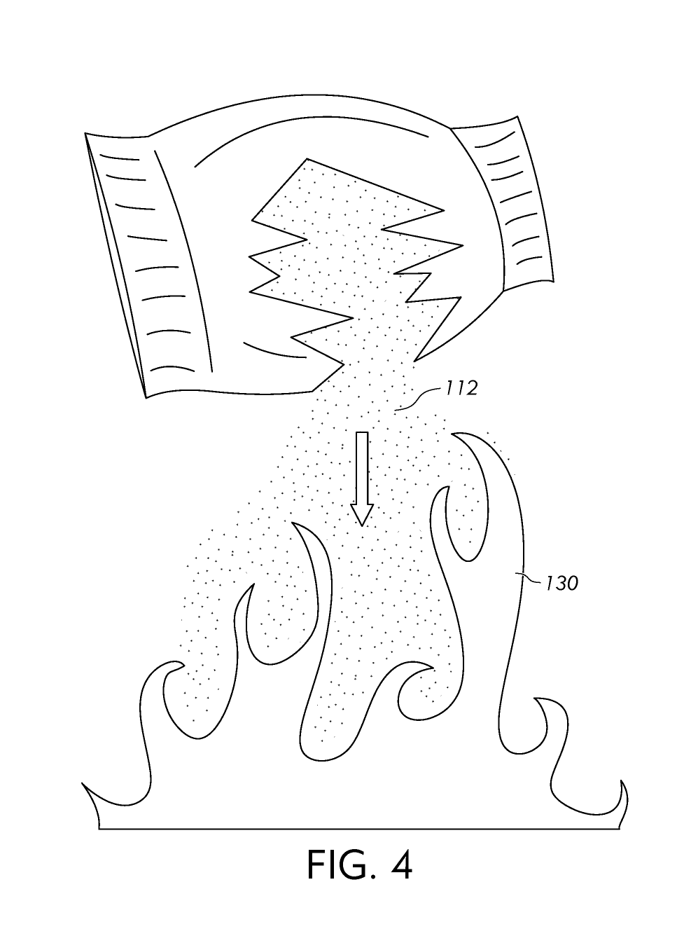

FIG. 4 is a perspective view of the fire extinguishing device of FIG. 1 during an ‘in-use’ condition, according to an embodiment of the present disclosure. Fire extinguishing agent 112 may comprise dispensable powder configured to smother chimney fire 130. Fire extinguishing agent 112 may further comprise monoammonium phosphate and ammonium sulfate in combination.

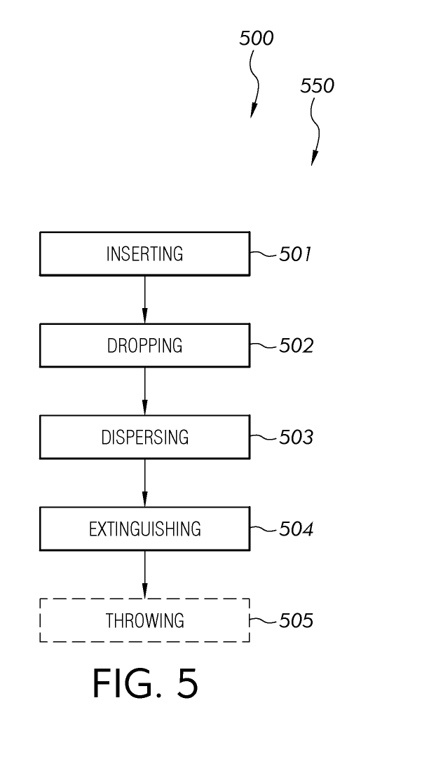

FIG. 5 is a flow diagram illustrating a method for extinguishing a chimney fire, according to an embodiment of the present disclosure. Generally, the fire extinguishing chimney bomb may be used to extinguish a chimney fire. The method of use may include first inserting the fire extinguishing chimney bomb containing the fire extinguishing material into a chimney flue, then dropping the fire extinguishing chimney bomb into the fire within the chimney, dispersing the fire extinguishing agent from the receptacle when in proximity to the fire, and subsequently extinguishing the fire. If necessary, the process may be repeated with additional fire extinguishing chimney bombs.

In particular, the method for extinguishing a chimney fire 500 may include one or more components or features of the fire extinguishing device 100 as described above. As illustrated, the method for extinguishing a chimney fire 500 may include the steps of: step one 501, inserting fire extinguishing device 100 into chimney flue 134, fire extinguishing device 100 including fire extinguishing agent 112 contained within receptacle 120; step two 502, dropping fire extinguishing device 100 into proximity of chimney fire 130 within chimney 132; step three 503, disbursing fire extinguishing agent 112 from receptacle 120 when in proximity to chimney fire 130; step four 504, extinguishing chimney fire 130; and step five 505, throwing a second fire extinguishing device 100 into proximity of chimney fire 130.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for extinguishing a chimney fire (e.g., different step orders within above-mentioned list, elimination or addition of certain steps, including or excluding certain maintenance steps, etc.), are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fire extinguishing device comprising:
a payload including a fire extinguishing agent configured to smother a chimney fire; and
a receptacle configured to contain the payload, to be thrown by hand, and to rupture and disperse the fire extinguishing agent upon exposure to heat above a predetermined temperature.

2. The fire extinguishing device of claim 1, wherein the fire extinguishing agent comprises a dispensable powder.

3. The fire extinguishing device of claim 1, wherein the fire extinguishing agent comprises a mixture of monoammonium phosphate and ammonium sulfate.

4. The fire extinguishing device of claim 1, wherein the receptacle comprises low-density polyethylene.

5. The fire extinguishing device of claim 1, wherein the receptacle comprises high-density polyethylene.

6. The fire extinguishing device of claim 1, wherein the receptacle comprises a flexible body.

7. The fire extinguishing device of claim 1, wherein the predetermined temperature is above 300 degrees Fahrenheit.

8. The fire extinguishing device of claim 1, wherein the receptacle defines an interior volume configured to contain the payload.

9. The fire extinguishing device of claim 1, wherein the receptacle is hermetically sealed.

10. The fire extinguishing device of claim 1, wherein the receptacle includes a cylindrical sheet having a first end, a second end opposite the first end along a center axis of the cylinder, a first sealed edge closing the first end of the cylindrical sheet, and a second sealed edge closing the second end of the cylindrical sheet.

11. The fire extinguishing device of claim 10, wherein the cylindrical sheet has a four inch diameter and a six inch axial length.

12. The fire extinguishing device of claim 10, wherein the cylindrical sheet measures no more than two millimeters thick, said cylindrical sheet being configured to immediately rupture upon exposure to a temperature above 300 degrees Fahrenheit.

13. The fire extinguishing device of claim 1, wherein the first sealed edge and the second sealed edge include plastic seams.

14. The fire extinguishing device of claim 1, wherein the receptacle is constructed of a polymer having a melting point below 300 degrees Fahrenheit, the receptacle being configured to melt and release the payload.

15. The fire extinguishing device of claim 1, wherein the payload comprises a multiplicity of particles configured to smother a fire and prevent a combustion reaction.

16. The fire extinguishing device of claim 1, wherein the receptacle includes a low-friction exterior surface configured to slide through a chimney flue.

17. A fire extinguishing chimney bomb comprising:
a payload including a fire extinguishing agent configured to smother a chimney fire; and
a receptacle configured to contain the payload, to be thrown by hand, and to rupture and disperse the fire extinguishing agent upon exposure to heat above a predetermined temperature; and
wherein the fire extinguishing agent comprises a dispensable powder;
wherein the fire extinguishing agent comprises a mixture of monoammonium phosphate and ammonium sulfate;
wherein the receptacle comprises polyethylene;
wherein the receptacle is a flexible body;
wherein the predetermined temperature is above 300 degrees Fahrenheit. wherein the receptacle defines an interior volume configured to contain the payload;
wherein exposure to heat causes the receptacle to rupture and disperse the fire extinguishing agent;
wherein the receptacle includes a cylindrical sheet having a first end, a second end opposite the first end along a center axis of the cylinder, a first sealed edge closing the first end of the cylindrical sheet, and a second sealed edge closing the second end of the cylindrical sheet.
wherein the cylindrical sheet has a four inch diameter and a six inch axial length.
wherein the first sealed edge and the second sealed edge include plastic welded seams;
wherein the cylindrical sheet measures no more than two millimeters thick, said cylindrical sheet being configured to immediately rupture upon exposure to a temperature above 300 degrees Fahrenheit;
wherein the receptacle is constructed of a polymer having a melting point below 300 degrees Fahrenheit, the receptacle being configured to melt and release the payload;
wherein the payload comprises a multiplicity of particles configured to smother a fire and prevent a combustion reaction; and
wherein the receptacle includes a low-friction exterior surface configured to slide through a chimney flue.

18. The fire extinguishing chimney bomb of claim 17, further comprising a set of instructions; and
wherein the fire extinguishing device is arranged as a kit.

19. A method of extinguishing a fire in a chimney, the method comprising the steps of:
inserting a fire extinguishing device into a chimney flue, the fire extinguishing device including a fire extinguishing agent contained within a receptacle;
dropping the fire extinguishing device into proximity of the fire within the chimney;
dispersing the fire extinguishing agent from the receptacle when in proximity to the fire; and
extinguishing the fire.

20. The method of claim 19, further comprising the steps of throwing a second fire extinguishing device into proximity of the fire.
